(19) United States
(12) Patent Application Publication
(10) Pub. No.: US 2005/0175864 A1
(43) Pub. Date: Aug. 11, 2005

(54) Magnetic thin film and magnetic head using the same

(75) Inventors: Shoji Ikeda, Kawasaki (JP); Takayuki Kubomiya, Kawasaki (JP); Masaaki Matsuoka, Kawasaki (JP); Ikuya Tagawa, Kawasaki (JP); Junichi Kane, Kawasaki (JP); Akifumi Chikazawa, Kawasaki (JP); Kazumasa Hosono, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/071,309

(22) Filed: Mar. 4, 2005

Related U.S. Application Data
(63) Continuation of application No. PCT/JP02/13264, filed on Dec. 18, 2002.

(51) Int. Cl. G11B 5/147

(52) U.S. Cl. 428/829

(57) ABSTRACT

The present invention relates to a magnetic thin film, which has high saturation magnetic flux density Bs of 2.2T or more, which is formed into a flat surface having surface roughness of 5 nm or less and which is capable of preferably being used for a write-head, and a magnetic head. The magnetic thin film includes a FeCo-based alloy layer stacked with a different layer so as to obtain the surface roughness of 5 nm or less. When forming the FeCo-based alloy layer, it is possible to flatten the film surface by performing reactive spattering using a reaction gas such as N₂ for each of the layers forming the multi-layered thin film.

### FIELD OF TECHNOLOGY

The present invention relates to a magnetic thin film and a magnetic head using the same, more precisely relates to a magnetic thin film, which has high saturation magnetic flux density Bs of 2.2T or more, which is formed into a flat surface having surface roughness of 5 nm or less and which is capable of preferably being used for a write-head, and a magnetic head using the same.

### BACKGROUND TECHNOLOGY

Sizes of recording bits have been made smaller to several hundreds nm or less with increase of surface recording density of recording media used for magnetic disk drive units, have been increased, and the sizes will be further smaller in the future. In such small size range, a problem of thermal agitation of magnetic fine particles is realized, so that recording media develop tendency to increase coercive forces (Hc). On the other hand, front end sections of magnetic poles are made narrower, so strong write-magnetic fields must be generated, further magnetic materials of the front end sections having high Bs (saturation magnetic flux density) values are required so as to access to the recording media having high Hc values.

A FeCo alloy has a high Bs value of 2.45T, so magnetic materials have been developed by forming a base layer under the alloy film as a buffer or adding a small amount of additive elements in the alloy. For example, a soft magnetic film, which is made of a FeCoN alloy and has a high Bs value of about 2.4T is reported in IEEE. Trans. Magn. vol. 36, pp. 2506-2508 (2000). However, it is difficult to control magnetic anisotropy in the single FeCoN film, thus the FeCoN layer is formed on a base layer made of permalloy (Ni₈₀Fe₂₀) or sandwiched with permalloy layers so as to improve soft magnetism. Note that, in the above described report, thickness of the FeCoN film is 1 μm, so a high Bs film of the front end section of the magnetic pole must be thicker so as to increase intensity of the write-magnetic field.

In Japanese Patent Gazette No. 10-270246, a granular alloy film, which is made by adding additive elements to the FeCo alloy and which has an anisotropic magnetic field Hk>20 Oe, a specific resistance ρ>50 μΩcm and Bs>1.6T. However, to make the specific resistance 50 μcm or more, amount of nonmagnetic elements must be increased, but the saturation magnetic flux density must be reduced, so it is difficult to obtain the high Bs value of 2.1T or more.

When the FeCo alloy is used, if a single film, whose thickness is thicker than 0.3 μm, is merely made of the FeCo alloy, sizes of crystal grains are made greater toward a surface of the film, so that a surface of the film must be rough. By the rough surface, diffuse reflection occurs in the surface in an exposing step with photo resist, so that accuracy of forming magnetic poles are varied. If this film is used as a seed layer of plating, abnormal deposition of a plating metal varies characteristics and thickness distribution of the plated films, further deformation of the magnetic pole lowers resolution of recording bits lower. As described above, using the single FeCo alloy layer has many problems as to characteristics of a magnetic head.

A soft magnetic film of the front end of the magnetic pole, which has a high Bs value, has been developed by forming a multi-layered film. In Japanese Patent Gazette No. 2001-15339, a soft magnetic multi-layered film, whose Bs=1.4-1.8T, is manufactured by alternately stacking ferromagnetic layers, each of which includes Fe, Co and Ni, and ferromagnetic layers, each of which includes Fe, Co, Ni and N, with nonmagnetic intermediate layers, which are made of a nonmagnetic nitride. However, the nonmagnetic intermediate layer is provided between the layers, so that the Bs value of the multi-layered film must be lowered.

In Japanese Patent Gazette No. 5-6834, a multi-layered film, whose Bs=1.7-2.0T, is manufactured by repeating a step of forming an alloy film including Fe and a step of irradiating N₂ plasma or N₂ ions to make a nitride layer. However, no multi-layered films having a high Bs of 2.2T or more are reported in the patent gazette, the surface roughness is not described, and adaptability to a magnetic head is not described, either. Further, thickness of the film is controlled by exposure time of N₂ plasma or N₂ ions; if reaction time is long to make a reaction layer thick, the reaction is exceedingly performed so that the film is non-magnetized, namely flexibility of selecting the film thickness must be low.

The present invention has been invented to solve the above described problems, and an object is to provide a magnetic thin film, which has high saturation magnetic flux density Bs, which is formed into a flat surface having surface roughness of 5 nm or less and which is capable of preferably being used for recording data in high density recording media having high coercivity, and a magnetic head using the same.

### DISCLOSURE OF THE INVENTION

The magnetic thin film of the present invention constituted by a multi-layered film comprises: a plurality of ferromagnetic first constituting layers, each of which includes iron Fe and cobalt Co; and a plurality of ferromagnetic second constituting layers, which have compositions or crystal structures different from those of the first constituting layers and each of which is provided between the first constituting layers, wherein surface roughness (Ra) of the magnetic thin film is 5 nm or less.

Each of the second constituting layers may be formed by reactive spattering using a reaction gas, such as N₂ gas, O₂ gas, after forming the first constituting layer. The second constituting layers is formed on each first constituting layer by reactive spattering, so that coarsening crystal grains can be restrained and the surface of the magnetic thin film can be flattened.

Preferably, a the first constituting layers are FeCo layers, and the second constituting layers are FeN layers; and the first constituting layers are FeCo layers, and the second constituting layers are FeCoN layers.

In the magnetic thin film, thicknesses of the first constituting layers and the second constituting layers may be designed to have saturation magnetic flux density Bs of 2.2T or more.

The magnetic head has a write-head whose front end section includes the magnetic thin film of the magnetic head, so the magnetic head can have high Bs and can be used for high density recording.

### BRIEF DESCRIPTION OF THE DRAWINGS

FIG. 1 is an explanation view showing a structure of a write-magnetic pole of a magnetic head;

FIGS. 2A and 2B are explanation views showing a method of producing the write-magnetic pole; and

FIGS. 3A and 3B are explanation views showing structures of magnetic thin films.

### PREFERRED EMBODIMENTS OF THE INVENTION

Preferred embodiments of the present invention will now be described in detail with reference to the accompanying drawings.

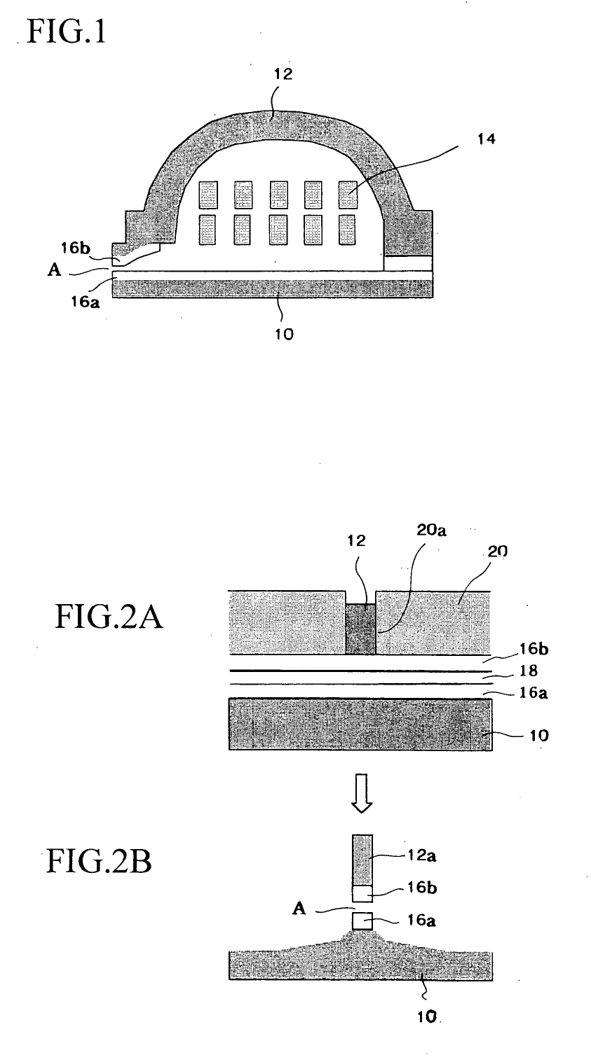

FIG. 1 is an explanation view showing a sectional structure of a write-head part of a magnetic head. In the drawing, a symbol 10 stands for a lower magnetic pole, a symbol 12 stands for an upper magnetic pole and a symbol 14 stands for a coil. The lower magnetic pole 10 and the upper magnetic pole 12 are made of a ferromagnetic material, e.g., NiFe. End faces of the lower magnetic pole 10 and the upper magnetic pole 12, which face a recording medium, are separated with a gap A, which acts as a write-gap. The gap A is included in a front section of a write-magnetic pole, and high Bs magnetic films 16a and 16b are respectively provided on inner faces of the lower magnetic pole 10 and the upper magnetic pole 12, which are mutually faced with the gap A. Data are recorded in the recording medium by magnetic fluxes leaked in the gap A from the end faces of the lower magnetic pole 10 and the upper magnetic pole 12. The high Bs magnetic films 16a and 16b increase intensity of a magnetic field for writing data.

FIGS. 2A and 2B are explanation views showing a method of producing the write-head including the gap. In FIG. 2A, the lower magnetic pole 10 is formed by plating, then the high Bs magnetic film 16a, a gap section 18 and the high Bs magnetic film 16b are formed in this order, further resist is applied on a surface of the high Bs magnetic film 16b, a resist pattern 20 is formed by exposing and developing the resist, and the upper magnetic pole 12 is formed by plating. Note that, the high Bs magnetic films 16a and 16b are formed by a method described later, and the gap section 18 is formed by spattering an insulating material, e.g., alumina. A groove 20a is formed in the resist patter 20 so as to form the end face of the upper magnetic pole 12 into a thin pillar-shape corresponding to a shape of an end face of the write-magnetic pole. When the resist pattern 20 is formed on the surface of the high Bs magnetic film 16b, the surface of the high Bs magnetic film 16b is exposed in a bottom face of the groove 20a, so the upper magnetic pole 12 is formed by growing a plating metal on the exposed surface of the high Bs magnetic film 16b.

In FIG. 2B, the write-magnetic pole is formed by ion milling or reactive ion etching after removing the resist pattern 20. By the etching step, an end section of the upper magnetic pole 12 is made slightly thinner, the high Bs magnetic films 16a and 16b and the gap section 18 are removed except the write-magnetic pole section, and a part of the lower magnetic pole 10, which is a side of the write-magnetic pole section, is carved.

In the write-head produced by the above described method, the high Bs magnetic films 16a and 16b have high Bs values capable of recording data with high recording density, further the surfaces of the high Bs magnetic films 16a and 16b are flattened so that the resist pattern 20 can be formed with high accuracy, variation of the gap distance and plating thickness can be restrained, and the write-head can have excellent characteristics. By flattening the surfaces of the high Bs magnetic films 16a and 16b, diffuse reflection on the surface of the high Bs magnetic films 16b can be restrained so that fine patterns can be formed with high accuracy. By reducing surface roughness of the high Bs magnetic films 16a and 16b, variation of the gap distance of the gap section 18 can be restrained. If the gap distance is too short, the surface roughness of the high Bs magnetic films 16a and 16b, which influence characteristics of the write-head, cannot be ignored. On the other hand, if the surface of the high Bs magnetic films 16b is flattened, abnormal deposition of a plating metal can be restrained, so that forming abnormal plated films and variation of thickness of plated films can be restrained.

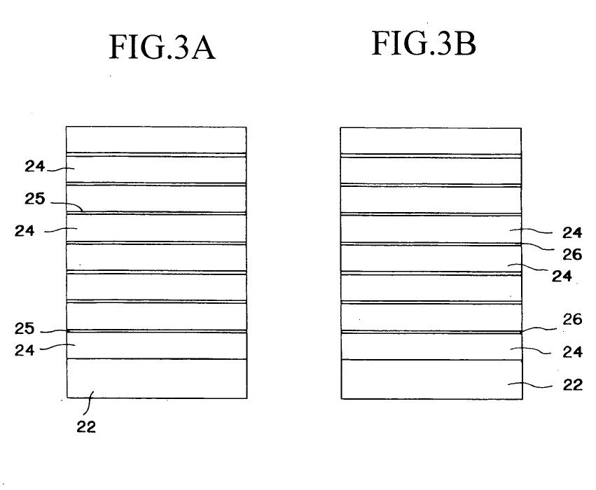

FIGS. 3A and 3B are explanation views showing examples of write-heads using the high Bs magnetic thin films 16a and 16b.

A sample of the magnetic thin film shown in FIG. 3A was formed by alternately performing spattering Fe₇₀CO₃₀ targets (at %) in an Ar gas and reactive-spattering Fe targets in a mixture gas of Ar+N₂. A symbol 22 stands for a base layer; symbols 24 stands for Fe₇₀CO₃₀ layers, and symbols 25 stand for FeN layers. Thickness of the Fe₇₀CO₃₀ layers 24 are 50 nm; thickness of the FeN layers 25 are 3 nm. The samples includes eight layers of the Fe₇₀CO₃₀ layers 24, and each of the FeN layers 25 is formed between the Fe₇₀CO₃₀ layers 24.

A sample of the magnetic thin film shown in FIG. 3B was formed by repeating the steps of: spattering a Fe₇₀CO₃₀ target in an Ar gas; introducing a N₂ gas into a vacuum chamber; and reacting the Fe₇₀CO₃₀ target with nitrogen by reactive spattering. In FIG. 3B, symbols 26 stand for FeCoN layers. In this sample too, eight layers of the Fe₇₀CO₃₀ layers 24 are formed, and each of the FeCoN layers 26 is formed between the Fe₇₀CO₃₀ layers 24.

The both samples were formed under the following conditions: pressure during the spattering were 0.1-3 Pa; electric power density of the spattering were 1-10⁻⁴ W/m²; and flow volume of nitrogen were 0.5-10 sccm. Distances between the targets and substrates were 90-180 mm. The substrates were made of TiO with Al₂O₃.

The Bs values and surface roughness Ra of the samples shown in FIGS. 3A and 3B are shown in TABLE 1. Further, those of a Fe₇₀CO₃₀ single film (thickness 400 nm) is shown as a comparative sample. The saturation magnetic flux density Bs was measured by SQUID with applying 10 KOe. The surface roughness Ra was measured by an atomic force microscope (AFM).

TABLE 1

| FILM STRUCTURE | BS(T) | Ra(nm) |
|---|---|---|
| Fe₇₀Co₃₀ single 400 nm | 2.45 | 10 |
| (Fe₇₀C₃₀ 50 nm/FeN 3 nm/Fe₇₀Co₃₀ 50 nm) × 4 | 2.4 | 2 |
| (Fe₇₀C₃₀ 50 nm/FeCoN 2 nm/Fe₇₀Co₃₀ 50 nm) × 4 | 2.4 | 3 |

In the Fe₇₀CO₃₀/FeN/Fe₇₀CO₃₀ multi-layered film and the Fe₇₀CO₃₀/FeCoN/Fe₇₀CO₃₀ multi-layered film, the surface roughness were 5 m or less, which were smaller than that of the Fe₇₀CO₃₀ single film, with maintaining the Bs value 2.4T. A reason of restraining the surface roughness is that the FeN layers and FeCoN layers, which were sporadically inserted, restrained coarsening of crystals caused by crystal growth, we think.

TABLE 2 shows visual surface conditions of the samples, whose surfaces were plated with Fe₆₄CO₂₈Ni₈ (at %) films grown on the Fe₇₀CO₃₀/FeN/Fe₇₀CO₃₀ multi-layered film and the Fe₇₀CO₃₀/FeCoN/Fe₇₀CO₃₀ multi-layered film as seed layers.

TABLE 2

| | CONDITION OF |
|---|---|
| | PLATED |
| FILM STRUCTURE | SURFACE |
| Fe₇₀Co₃₀ single 400 nm | TARNISH |
| (Fe₇₀C₃₀ 50 nm/FeN 3 nm/Fe₇₀Co₃₀ 50 nm) × 4 | LUSTER |
| (Fe₇₀C₃₀ 50 nm/FeCoN 2 nm/Fe₇₀Co₃₀ 50 mn) × 4 | LUSTER |

The both multi-layered films had metallic luster. On the other hand, the surface of the comparative sample, which was plated on the Fe₇₀CO₃₀ single film (thickness 400 nm) as a seed layer, was tarnished with low flatness. A reason is that surface roughness of the seed layer badly influenced growth of the plated film, we think.

In case of using the Fe₇₀CO₃₀/FeN/Fe₇₀CO₃₀ multi-layered film and the Fe₇₀CO₃₀/FeCoN/Fe₇₀CO₃₀ multi-layered film as base layers of exposure, diffusion of light reflected on the base layers could be smaller than that reflected on a base layer made of the Fe₇₀CO₃₀ single film, so that variation of patterns were restrained.

Note that, flattening the surfaces of the films can be performed by forming oxide layers, which are formed by reactive spattering with O₂ as a reactive gas, on the FeCo layers. The oxide layers work as well as the FeN layers and the FeCoN layers described above, we think.

As we have described above, by using the high Bs magnetic thin film of the present invention, fraction defective of magnetic heads, which is influenced by surface roughness of magnetic films, can be lowered, and yield of mass-producing magnetic heads can be improved. Further, the write-heads having strong write-magnetic fields can be formed, so that the magnetic thin film can be provided for magnetic heads capable of recording data with high recording density.

1. A magnetic thin film constituted by a multi-layered film comprising: a plurality of ferromagnetic first constituting layers, each of which includes iron Fe and cobalt Co; and a plurality of ferromagnetic second constituting layers, which have compositions or crystal structures different from those of said first constituting layers and each of which is provided between said first constituting layers,
wherein surface roughness (Ra) of said magnetic thin film is 5 nm or less.

2. The magnetic thin film according to claim 1, wherein each of said second constituting layers is formed by reactive spattering using a reaction gas, such as N₂ gas, O₂ gas, after forming said first constituting layer.

3. The magnetic thin film according to claim 1, wherein said first constituting layers are FeCo layers, and said second constituting layers are FeN layers.

4. The magnetic thin film according to claim 2, wherein said first constituting layers are FeCo layers, and said second constituting layers are FeN layers.

5. The magnetic thin film according to claim 1, wherein said first constituting layers are FeCo layers, and said second constituting layers are FeCoN layers.

6. The magnetic thin film according to claim 2, wherein said first constituting layers are FeCo layers, and said second constituting layers are FeCoN layers.

7. The magnetic thin film according to claim 1, wherein thicknesses of said first constituting layers and said second constituting layers are designed to have saturation magnetic flux density Bs of 2.2T or more.

8. The magnetic thin film according to claim 2, wherein thicknesses of said first constituting layers and said second constituting layers are designed to have saturation magnetic flux density Bs of 2.2T or more.

9. The magnetic thin film according to claim 3, wherein thicknesses of said first constituting layers and said second constituting layers are designed to have saturation magnetic flux density Bs of 2.2T or more.

10. The magnetic thin film according to claim 4, wherein thicknesses of said first constituting layers and said second constituting layers are designed to have saturation magnetic flux density Bs of 2.2T or more.

11. The magnetic thin film according to claim 5, wherein thicknesses of said first constituting layers and said second constituting layers are designed to have saturation magnetic flux density Bs of 2.2T or more.

12. The magnetic thin film according to claim 6, wherein thicknesses of said first constituting layers and said second constituting layers are designed to have saturation magnetic flux density Bs of 2.2T or more.

13. A magnetic head having a write-head whose front end section includes said magnetic thin film of claim 1.

14. The magnetic head according to claim 13, wherein said magnetic thin film is used as a seed layer of plating, and an upper magnetic pole is formed by plating.
